(19) United States
(12) Patent Application Publication
(10) Pub. No.: US 2026/0128907 A1
(43) Pub. Date: May 7, 2026

(54) Methods and systems of provisioning content authenticity

(71) Applicants: Alexandru E. Denes, Fresno, CA (US); Alexander Brandon Denes, Fresno, CA (US)

(72) Inventors: Alexandru E. Denes, Fresno, CA (US); Alexander Brandon Denes, Fresno, CA (US)

(21) Appl. No.: 19/376,994

(22) Filed: Nov. 2, 2025

Related U.S. Application Data
(60) Provisional application No. 63/716,584, filed on Nov. 5, 2024.

(51) Int. Cl. H04L 9/32; H04L 9/00; H04L 9/08

(52) U.S. Cl. CPC H04L 9/3247; H04L 9/0825; H04L 9/3231; H04L 9/3263; H04L 9/50

(57) ABSTRACT

The present invention discloses a system and method for provisioning content authenticity. The system comprises a computing device, a database in communication with the computing device via a network, and an author device associated with an author. The author device is in communication with the computing device via the network. The computing device is configured to receive identity data from the author device and verify the identity data of the author. The computing device generates a digital signature based on the identity data and embeds the digital signature into content data received from the author device. The computing device generates a content integrity score (CIS) for the content data and a verification badge based on the CIS. The CIS quantifies human input and AI contribution levels. The system transmits the verification badge data, comprising the content data and the digital signature, to an entity device to provide verifiable content authenticity.

### TECHNICAL FIELD

The present invention generally relates to data processing. More specifically, the present invention relates to a system and method for provisioning of content authenticity.

### BACKGROUND

The existing technologies for provisioning content authenticity are deficient with regard to several aspects. Furthermore, content authenticity is necessary to provide genuine credit to the author of the content. Furthermore, content authenticity may provide assurance to the readers about the originality of the content. Hence, providing trustworthy content to the reader. Further, the existing technologies are inefficient in providing verified content to the readers. Furthermore, the existing technologies further rely on third-party intermediaries for verifying authenticity between two or more parties. Such reliance reduces efficiency, increases cost, introduces bias, and creates additional security risks. Furthermore, the existing technologies are deficient in recording immutable content.

Additionally, the existing technologies do not provide transparent mechanisms for validating the chain of custody of content from creation to distribution. Further, the existing technologies lack standardized methods for proving integrity when content is transferred, stored, or modified, thereby allowing potential manipulation to go undetected. In addition, the existing technologies fail to establish a universally trusted framework for verification that can operate independently of centralized control. These shortcomings further weaken reliability, limit scalability, and restrict adoption of content authenticity solutions.

Therefore, there is a need for improved methods and systems for provisioning of content authenticity.

### SUMMARY

The present invention discloses a system and method for provisioning of content authenticity. The system comprises at least one computing device comprising at least one processor and a memory storing a plurality of program modules. The system further comprises at least one database in communication with the computing device via a network. The system further comprises at least one author device associated with an author, the author device in communication with the computing device via the network. The computing device is configured to receive identity data from the author device and verify the identity data of the author. The computing device generates a digital signature data based on the identity data using a signature artificial intelligence model. The computing device is further configured to receive content data from the author device and embed the digital signature data into the content data. The computing device generates a content integrity score (CIS) data for the content data and a verification badge data based on the content integrity score data. The CIS data is calculated based on at least one of the extents of manual author input, the extent of use of artificial intelligence tools, and the amount of artificial intelligence-generated content within the content data. The computing device transmits the verification badge data to an entity device. The verification badge data comprises the content data including the digital signature data.

In one embodiment, the computing device is configured to generate the digital signature data by transmitting the identity data to a certification authority entity and receiving digital certificate data from the certification authority entity. The digital certificate data represents a certificate issued by the certification authority entity to validate the identity data. The digital signature data comprises the digital certificate data. In another embodiment, the computing device verifies the identity data of the author by performing multi-factor authentication. The identity data comprises biometric data and identification documents issued by a certified authority, and the computing device analyzes the biometric data and the identification documents to verify the identity data. The computing device can also generate a verification query based on the identity data, transmit the verification query to the author device, and receive a verification response data from the author device.

The computing device is further configured to transform the content data comprising the digital signature data into a plurality of content data comprising the corresponding digital signature data, perform a first analysis of the plurality of content data, generate a hierarchical content data structure comprising the plurality of content data, and store the hierarchical content data structure. The hierarchical content data structure is associated with a corresponding index data and can be accessed based on the index data. Similarly, the computing device transforms the identity data into a plurality of identification data, performs a second analysis of the plurality of identification data, and generates a hierarchical data structure comprising the plurality of identification data. Each identification data is associated with an index data configured to allow accessing the corresponding identity data within the hierarchical data structure based on the index data.

The computing device is further configured to transform the content data comprising the digital signature data into a plurality of content data, perform a third analysis of the plurality of content data, generate a plurality of blocks comprising the plurality of content data, and transmit the plurality of blocks across the network associated with a plurality of devices. The devices include the author device and the entity device. The computing device receives alternate content data from the author device and updates the plurality of blocks accordingly. The verification badge data comprises at least one of the content data and a public key data. The computing device is further configured to transmit the verification badge data and content integrity score to a blockchain node for storage in a distributed ledger.

The computing device receives the content data by providing an author interface at the author device to allow creation, editing, and uploading of the content data. The computing device performs ongoing biometric verification of the author during content creation, generates a hash value of the content data, automatically generates metadata associated with the content data, and transmits the hash value and metadata to the blockchain node for storage in a distributed ledger maintained by a plurality of blockchain nodes across the network.

The verification badge data comprises at least one verification badge indicating the type of content generation, including human-generated content, human content assisted by artificial intelligence, content generated by artificial intelligence, or content generated through a combination of human input and artificial intelligence. The verification badge is visually embedded within the content data and is selectable to display details about the content integrity score and the level of human versus artificial intelligence involvement in creating the content data.

After embedding the digital signature data and verifying originality, the content data is time-stamped and recorded on a blockchain ledger comprising a log of subsequent changes to the content data. The blockchain ledger is publicly accessible for verification of authorship, metadata, digital signature data, verification badge, content integrity score, version history, and subsequent modifications of the content data.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 exemplarily illustrates an environment of a system for provisioning of content authenticity, according to an embodiment of the present invention.

FIG. 2 exemplarily illustrates a block diagram of the computing device connected to author devices, according to an embodiment of the present invention.

FIG. 3 exemplarily illustrates a flowchart of a method for provisioning of content authenticity, according to an embodiment of the present invention.

FIG. 4 exemplarily illustrates a flowchart of a method for generating digital signature data, according to an embodiment of the present invention.

FIG. 5 exemplarily illustrates a flowchart of a method for verifying identification data, according to an embodiment of the present invention.

FIG. 6 exemplarily illustrates a flowchart of a method for generating and storing a hierarchical content data structure, according to an embodiment of the present invention.

FIG. 7 exemplarily illustrates a flowchart of a method for generating and storing a hierarchical identification data structure, according to an embodiment of the present invention.

FIG. 8 exemplarily illustrates a flowchart of a method for generating and transmitting content blocks, according to an embodiment of the present invention.

FIG. 9 exemplarily illustrates a flowchart of a method for generating and transmitting content blocks, according to another embodiment of the present invention.

FIG. 10 exemplarily illustrates a flowchart of a method for creating content data, according to an embodiment of the present invention.

### DETAILED DESCRIPTION OF EXAMPLE EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

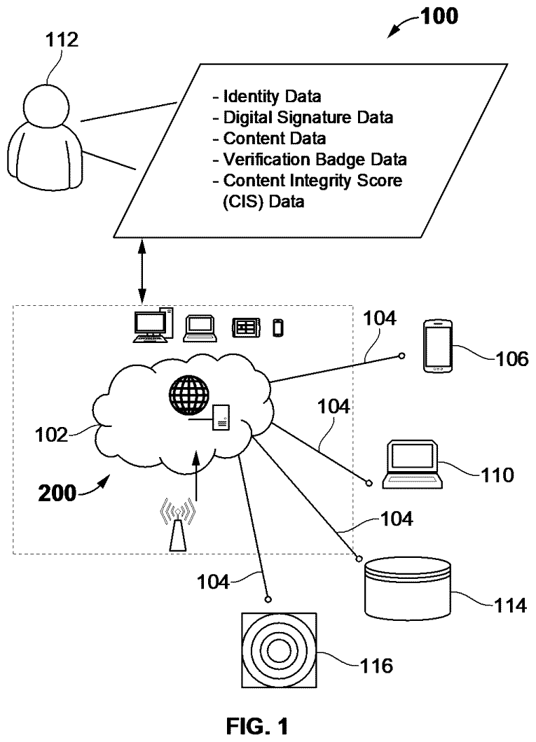

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but may not be limited to, the Internet. Further, users of the online platform 100 may include relevant parties such as, but may not be limited to, end-users, administrators, service providers, service consumers and so on. Accordingly, in some instances, electronic devices operated by the one or more relevant parties may be in communication with the platform. A user 112, such as the one or more relevant parties, may access online platform 100 through a web-based software application or browser. The web-based software application may be embodied as, for example, but not be limited to, a website, a web application, a desktop application, and a mobile application compatible with a computing device 200. In one embodiment, the centralized server 102 includes the computing device 200. In one embodiment, a computing device associated with a user, for example an author, is referred to as an author device, and a computing device associated with an entity is referred to as an entity device.

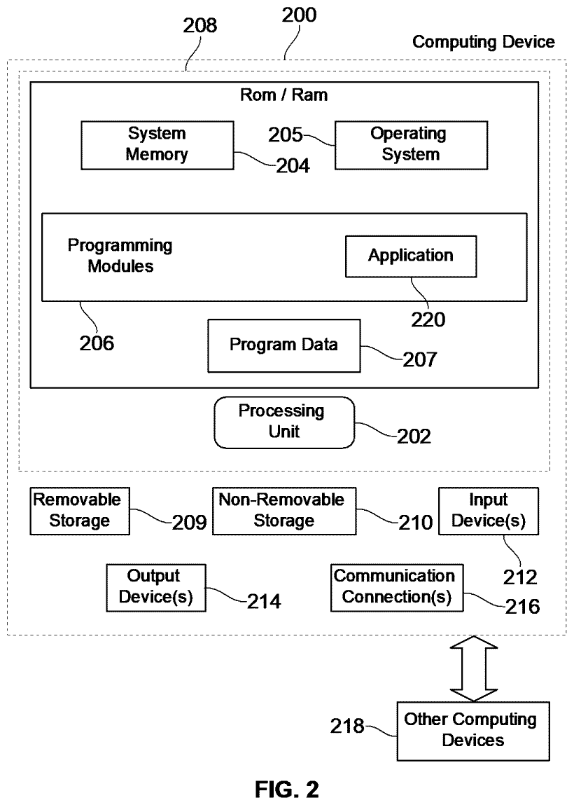

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but may not be limited to, volatile (e.g., random-access memory (RAM)), nonvolatile (e.g., read-only memory (ROM)), flash memory, or any combination. System memory 204 may include operating system 205, one or more programming modules 206, and may include program data 207. Operating system 205, for example, may be suitable for controlling computing device 200's operation. In one embodiment, programming modules 206 may include image processing module, machine learning module. Furthermore, embodiments of the disclosure may be practiced in conjunction with a graphics library, other operating systems, or any other application program and may not be limited to any particular application or system. This basic configuration may be illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage may be illustrated in FIG. 2 by a removable storage 209 and a non-removable storage 210. Computer storage media may include volatile and nonvolatile, removable and non-removable media implemented in any method or technology for storage of information, such as computer-readable instructions, data structures, program modules, or other data. System memory 204, removable storage 209, and nonremovable storage 210 may be all computer storage media examples (i.e., memory storage.) Computer storage media may include, but may not be limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which may be used to store information and which may be accessed by computing device 200. Any such computer storage media may be part of device 200.

Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices may be examples and others may be used. Computing device 200 may also contain a communication connection 216 that may allow device 200 to communicate with other computing devices 218, such as over a network in a distributed computing environment, for example, an intranet or the Internet. Communication connection 216 may be one example of communication media. Communication media may typically be embodied by computer readable instructions, data structures, program modules, or other data in a modulated data signal, such as a carrier wave or other transport mechanism, and may include any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radiofrequency (RF), infrared, and other wireless media. The term computer readable media as used herein may include both storage media and communication media. As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process may be an example, and processing unit 202 may perform other processes.

Other programming modules that may be used in accordance with embodiments of the present disclosure may include machine learning applications. Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks may be performed by remote processing devices that may be linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but may not be limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that may contain, store, communicate, propagate, or transport the program for use by or in connection with the instruction execution system, apparatus, or device.

The computer-usable or computer-readable medium may be, for example but may not be limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program may be printed, as the program may be electronically captured, via, for instance, optical scanning of the paper or other medium, then compiled, interpreted, or otherwise processed in a suitable manner, if necessary, and then stored in a computer memory. Embodiments of the present disclosure, for example, may be described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data may also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

The system further comprises at least one database in communication with the computing device 200 via the network 104. The database comprises data related to author and data for providing content authenticity. The computing device 200 is configured to provision content authenticity by receiving identity data from an author device. The computing device 200 is further configured to verify the identity data of the author.

The computing device 200 is further configured to generate digital certificate data by transmitting the identity data to a certification authority entity. The computing device 200 is further configured to receive the digital certificate data from the certification authority entity. The digital certificate data validates the identity data and forms part of the digital signature data. In another embodiment, the computing device 200 is further configured to verify the identity data of the author using multi-factor authentication. The identity data comprises biometric data.

The computing device 200 is further configured to verify the identity data by generating a verification query based on the identity data. The computing device 200 is further configured to transmit the verification query to the author device. The computing device 200 is further configured to receive a verification response from the author device.

In one embodiment, the computing device 200 is further configured to transform content data comprising digital signature data into a plurality of corresponding content data. The computing device 200 is further configured to perform a first analysis of the plurality of content data. The computing device 200 is further configured to generate a hierarchical content data structure based on the first analysis. The computing device 200 is further configured to store the hierarchical content data structure associated with index data for access and retrieval.

In another embodiment, the computing device 200 is further configured to transform the identity data into a plurality of identification data. The computing device 200 is further configured to perform a second analysis of the identification data. The computing device 200 is further configured to generate a hierarchical data structure of the identification data. Each identification data is associated with index data allowing access to corresponding identity data within the hierarchical structure.

The computing device 200 is further configured to transform the content data comprising digital signature data into a plurality of blocks. The computing device 200 is further configured to perform a third analysis of the content data. The computing device 200 is further configured to transmit the plurality of blocks across a communication network to a plurality of devices including the author device and the entity device.

In another embodiment, the computing device 200 is further configured to receive alternate content data from the author device. The computing device 200 is further configured to update the plurality of blocks based on the alternate content data.

The computing device 200 is further configured to provide an author interface at the author device. The interface allows creation, editing, and uploading of content data. The computing device 200 is further configured to perform ongoing biometric verification of the author during content creation. The computing device 200 is further configured to generate a hash value of the content data. The computing device 200 is further configured to automatically generate metadata associated with the content data.

The computing device 200 is further configured to transmit the hash value, digital signature data, and metadata to a blockchain node. The blockchain node stores the received information in a distributed ledger. The distributed ledger is maintained by a plurality of blockchain nodes across the network 104.

The computing device 200 is further configured to generate a content integrity score (CIS) for the content data. The CIS is calculated based on the extent of manual author input, the extent of use of artificial intelligence tools, and the amount of artificial intelligence-generated content. The computing device 200 is further configured to store the CIS in the distributed ledger associated with the content data.

The computing device 200 is further configured to assign a verification badge to the content data based on the content integrity score. The verification badge is visually embedded within the content data. The computing device 200 is further configured such that the verification badge indicates whether the content is human-generated, human-generated with artificial intelligence assistance, generated substantially by artificial intelligence, or generated through a hybrid of human input and artificial intelligence.

The computing device 200 is further configured such that the verification badge is linked to the blockchain record. The blockchain ledger further includes content integrity score of the content data. The computing device 200 is further configured such that the verification badge is selectable to display supplementary information. The supplementary information includes details regarding the content integrity score and the degree of human versus artificial intelligence involvement in creating the content.

The computing device 200 is further configured to time-stamp and record content data on the blockchain after embedding the digital signature and verifying originality. The blockchain ledger comprises the author's digital signature, file metadata, content integrity score, and a log of subsequent changes. The computing device 200 is further configured to publish the content data with the verification badge linked to the blockchain ledger. The badge provides access to information regarding authorship, metadata, and modification history. The computing device 200 is further configured to make the blockchain record publicly accessible. The public access allows verification of authorship, metadata, version history, and subsequent modifications of the content data.

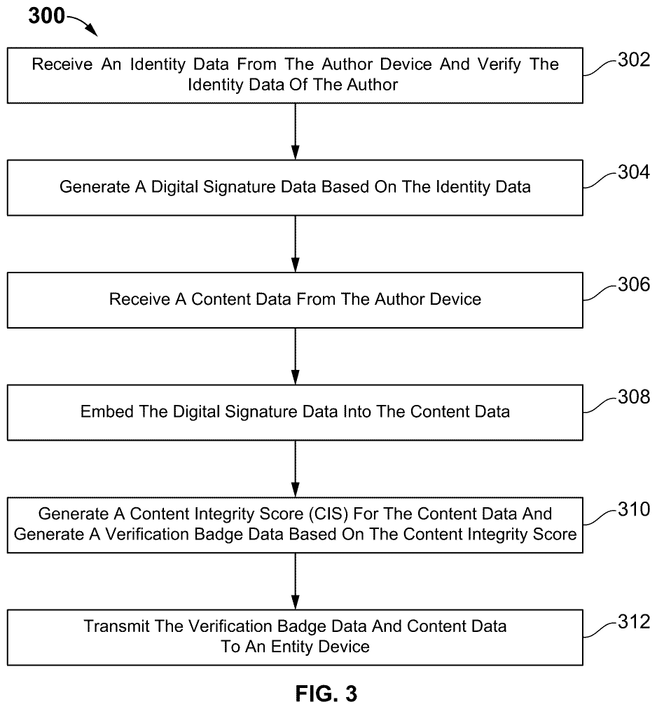

FIG. 3 exemplarily illustrates a flowchart 300 of a method for provisioning of content authenticity, according to an embodiment of the present invention. At step 302, the computing device 200 receives identity data from the author device and verifies the identity data of the author. The identity data may include personal information such as name, contact details, and email address. In some embodiments, the author is further required to agree to the platform's terms and conditions and complete the registration process. The computing device 200 employs biometric verification. The computing device 200 is configured to receive identity data including biometric data such as facial recognition, fingerprint scan, or voice recognition data. In addition, the computing device 200 is configured to prompt the author to submit government-issued identification documents, for example, a passport or driver's license, to support the identity verification. The computing device 200 further utilizes one or more AI algorithms to analyse and cross-check the biometric data against the submitted identification documents to ensure accuracy and authenticity. In yet another embodiment, the computing device 200 is configured to implement multi-factor authentication (MFA) as part of the identity verification process. The MFA requires the author to provide a password and an additional authentication factor, such as a one-time code or security token. The identity verification step ensures that only verified authors are associated with the content data, thereby reducing risks of impersonation, fraudulent authorship, and unauthorized content submissions.

At step 304, the computing device 200 generates digital signature data based on the identity data. In one embodiment, the generation is based on a signature artificial intelligence model.

In another embodiment, the computing device 200 generates a digital signature, which constitutes a secure, personal identifier directly linked to the author's biometric identity. The digital signature functions as a digital equivalent of a handwritten signature, providing a verifiable association between the author and the content. The computing device 200 applies the digital signature to all subsequent content uploads to verify authorship. A copy of the digital signature is securely stored on the blockchain, creating a permanent and immutable record. Accordingly, the author's identity can be confirmed at any time, and any modification to the content after its creation can be traced through the blockchain ledger to the original author or to any other author that subsequently modifies the digital file. This process ensures content credibility and provides enduring proof of authorship.

At step 306, the computing device 200 receives content data from the author device. At step 308, the computing device 200 embeds the digital signature data into the content data. At step 310, the computing device 200 generates a content integrity score (CIS) for the content data and generates verification badge data based on the content integrity score. The CIS data comprising a content integrity score is calculated based on at least one of an extent of manual author input, an extent of use of artificial intelligence tools, and an amount of artificial intelligence generated content within the content data. At step 312, the computing device 200 transmits the verification badge data and the content data to an entity device. The verification badge data comprises the content data comprising the digital signature data.

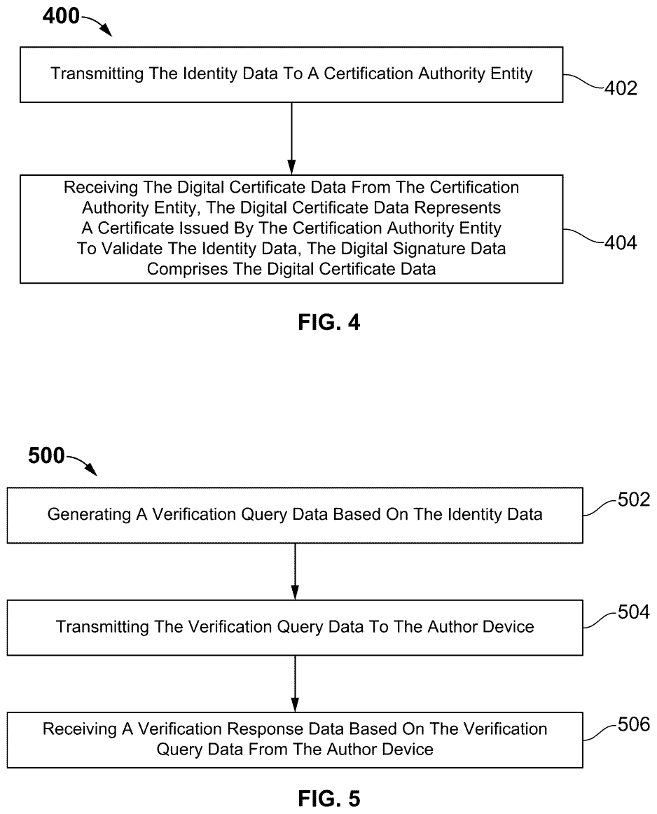

FIG. 4 exemplarily illustrates a flowchart 400 of a method for generating digital signature data, according to an embodiment of the present invention. At step 402, the computing device 200 transmits the identity data to a certification authority entity. At step 404, the computing device 200 receives digital certificate data from the certification authority entity. The digital certificate data represents a certificate issued by the certification authority entity to validate the identity data. The digital signature data includes the digital certificate data.

FIG. 5 exemplarily illustrates a flowchart 500 of a method for verifying identification data, according to an embodiment of the present invention. At step 502, the computing device 200 generates verification query data based on the identity data. At step 504, the computing device 200 transmits the verification query data to the author device. At step 506, the computing device 200 receives verification response data from the author device based on the verification query data.

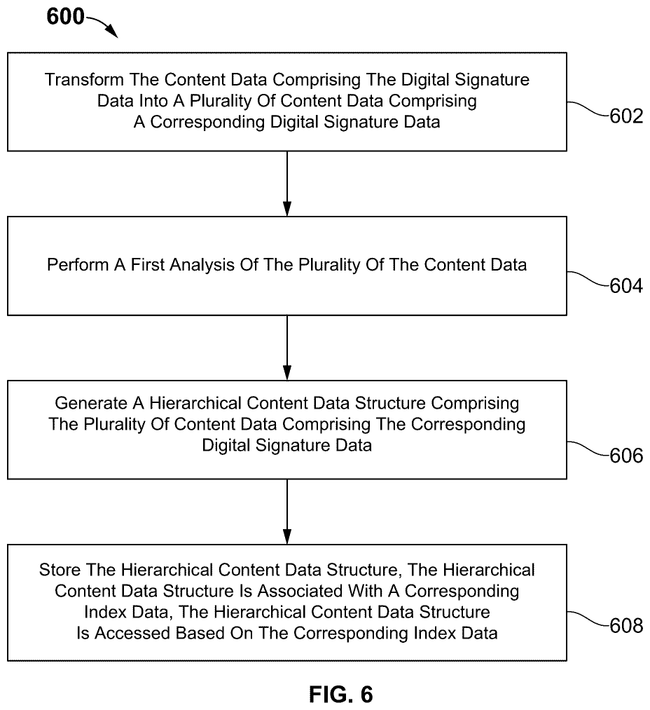

FIG. 6 exemplarily illustrates a flowchart 600 of a method for generating and storing a hierarchical content data structure, according to an embodiment of the present invention. At step 602, the computing device 200 transforms the content data comprising the digital signature data into a plurality of content data comprising corresponding digital signature data. At step 604, the computing device 200 performs a first analysis of the plurality of content data. At step 606, the computing device 200 generates a hierarchical content data structure comprising the plurality of content data comprising the corresponding digital signature data. The generation is based on the first analysis. At step 608, the computing device 200 stores the hierarchical content data structure. The hierarchical content data structure is associated with corresponding index data and is accessed based on the corresponding index data.

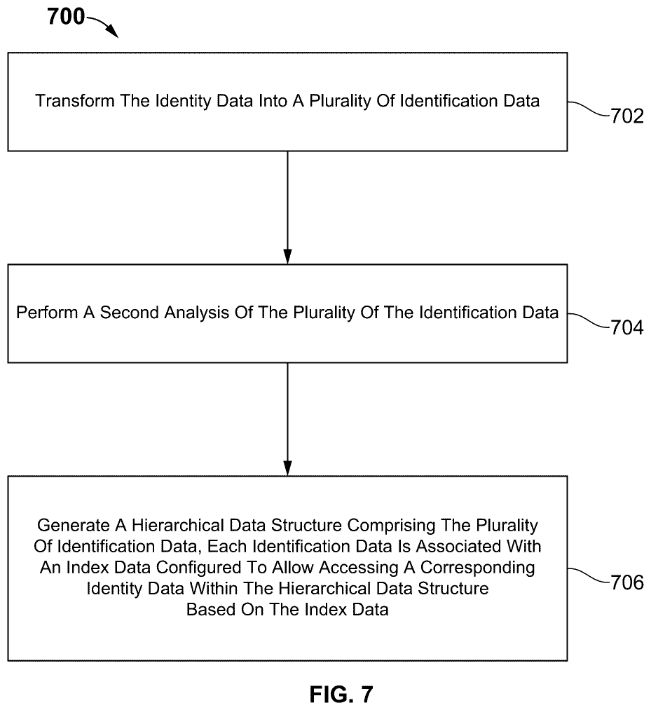

FIG. 7 exemplarily illustrates a flowchart 700 of a method for generating and storing a hierarchical identification data structure, according to an embodiment of the present invention. At step 702, the computing device 200 transforms the identity data into a plurality of identification data. At step 704, the computing device 200 performs a second analysis of the plurality of identification data. At step 706, the computing device 200 generates a hierarchical data structure comprising the plurality of identification data, the generation being based on the second analysis. Each identification data is associated with an index data configured to allow accessing a corresponding identity data within the hierarchical data structure based on the index data. The generation of the digital signature data is further based on accessing the hierarchical data structure.

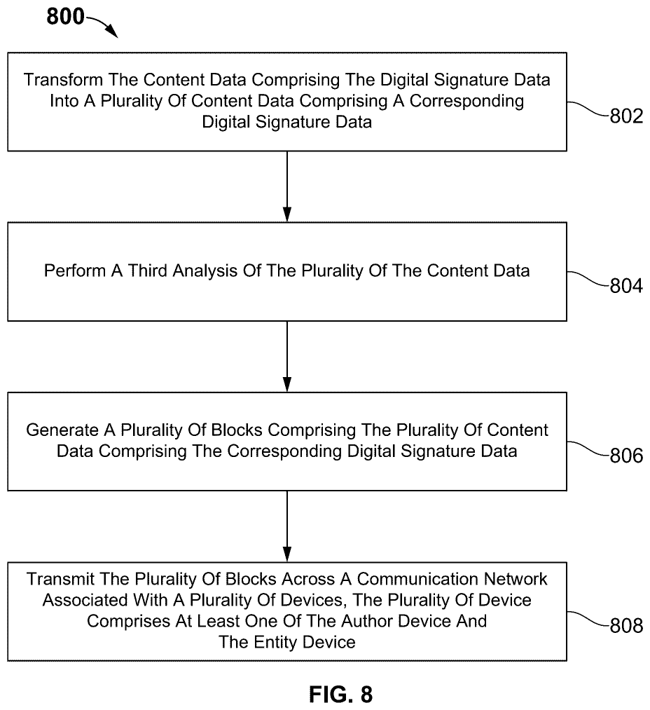

FIG. 8 exemplarily illustrates a flowchart 800 of a method for generating and transmitting content blocks, according to an embodiment of the present invention. At step 802, the computing device 200 transforms the content data comprising the digital signature data into a plurality of content data comprising corresponding digital signature data. At step 804, the computing device 200 performs a third analysis of the plurality of content data. At step 806, the computing device 200 generates a plurality of blocks comprising the plurality of content data comprising the corresponding digital signature data, the generation being based on the third analysis. At step 808, the computing device 200 transmits the plurality of blocks across a communication network associated with a plurality of devices. The plurality of devices including one or more author devices and the entity devices.

In some embodiments, the author device includes a camera configured to detect a face of the author. The author device further includes the computing device 200 coupled with the camera, the computing device 200 being configured to generate facial data based on the detection. The identity data includes the facial data.

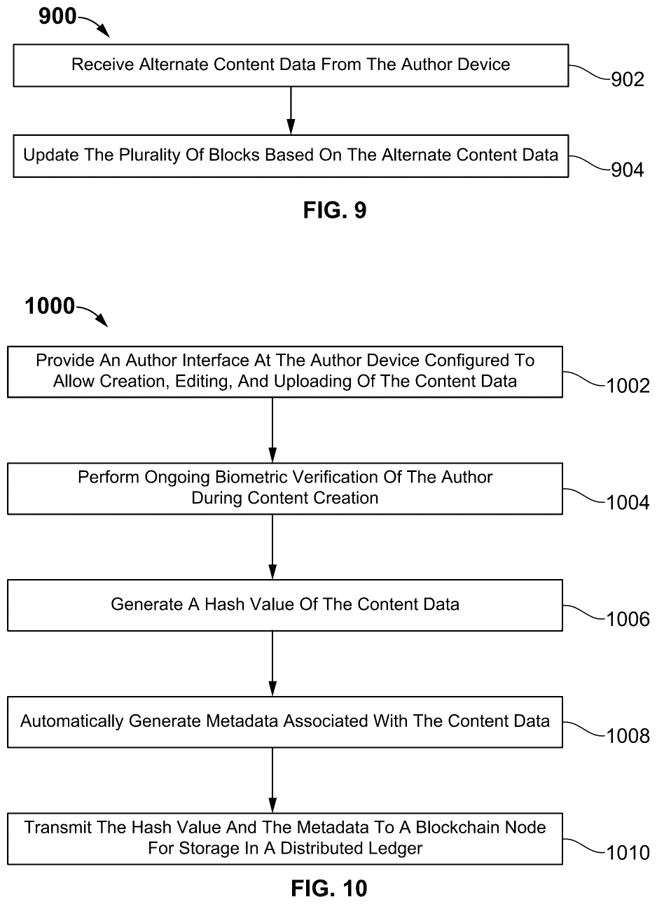

FIG. 9 exemplarily illustrates a flowchart 900 of a method for generating and transmitting content blocks, according to another embodiment of the present invention. At step 902, the computing device 200 receives alternate content data from the author device. At step 904, the computing device 200 updates the plurality of blocks based on the alternate content data. The identity data includes author profile data. At step 906, the computing device 200 generates a dashboard based on the author profile data. The dashboard includes one or more content data received from the author, and at least one reader associated with the entity device is allowed to access the dashboard.

FIG. 10 exemplarily illustrates a flowchart 1000 of a method for creating content data, according to an embodiment of the present invention. At step 1002, the computing device 200 provides an author interface at the author device configured to allow creation, editing, and uploading of the content data. The author interface enables the authors to create or upload content to the platform. The content includes written articles, blog posts, videos, images, or audio recordings. The computing device 200 is configured to support multiple content formats, thereby enabling the author device to create and work with different types of media. The computing device 200 allows the author device to perform editing and improvements to the content prior to proceeding to the subsequent step.

At step 1004, the computing device 200 performs ongoing biometric verification of the author during content creation. For lengthy projects, the computing device 200 prompts the author at regular intervals to perform biometric checks, such as facial recognition or fingerprint scans, to confirm that the verified author is actively involved. These checks prevent unauthorized individuals from altering or influencing the content and help accurately tag hybrid content involving AI tools. The biometric verification is quick, minimally disruptive, and ensures continuous authorship integrity.

At step 1006, the computing device 200 generates a hash value of the content data. The computing device 200 applies a cryptographic algorithm to the content to generate a unique fingerprint or hash value. The computing device 200 generates a hash value such that any modification to the content produces a different hash value, thereby enabling detection of alterations. The hash value is stored on a blockchain to ensure tamper-proof storage.

At step 1008, the computing device 200 automatically generates metadata associated with the content data. The metadata includes information such as the author's name, date of creation, version number, and a description of the content. The metadata may also include the original publication source. The metadata is attached to the content and stored on the blockchain, providing transparency, traceability, and a permanent record of the content's lifecycle.

At step 1010, the computing device 200 transmits the hash value and the metadata to a blockchain node for storage in a distributed ledger, ensuring that the content remains secure, verifiable, and immutable.

In yet another embodiment, the computing device 200 generates a Content Integrity Score (CIS) for the content data. The CIS quantifies the extent of human versus AI involvement in content creation. The computing device 200 analyzes factors such as the degree of manual input during content creation, use of AI tools, and the level of AI-generated assistance. For example, content created entirely by a human will result in a higher human-involvement score, whereas content heavily assisted or generated by AI will reflect higher AI involvement.

The computing device 200 interfaces with AI-powered originality verification services to determine the AI contribution in the content. These services evaluate the proportion of the content generated by AI versus that produced by the human author. The computing device 200 logs the CIS and stores it as part of the content's blockchain verification record, providing a transparent, immutable record of the content's authenticity. In yet another embodiment, the computing device 200 assigns a verification badge to the content data based on the CIS.

The verification badge includes at least one first verification badge. The first verification badge represents content that has been created entirely by a human without any AI assistance. The first verification badge enables readers to identify content that is purely the result of human effort and creativity, providing the highest level of human originality and authenticity.

The verification badge includes at least one second verification badge. The second verification badge represents content that has been generated using AI tools under direct human guidance and control, wherein the author actively uses AI as an aid, such as generating ideas, rewriting paragraphs, or providing suggestions, while maintaining creative oversight. The second verification badge enables readers to distinguish collaborative content in which AI functions as a tool rather than the sole creator, indicating that human authorship remains central.

The verification badge includes at least one third verification badge. The third verification badge represents content that has been fully generated by AI without significant human involvement, including articles, reports, or multimedia produced autonomously by AI systems. The third verification badge enables readers to identify content that lacks human oversight, assisting in evaluating reliability, potential biases, and the level of automation in content creation.

The verification badge includes at least one fourth verification badge. The fourth verification badge represents content produced through a combination of human effort and AI automation, wherein AI actively participates in multiple stages of the content creation process. The fourth verification badge enables readers to recognize hybrid content that is neither purely human nor purely AI, providing a nuanced understanding of the collaboration between human authors and AI systems.

In yet another embodiment, the computing device 200 embeds the verification badge into the content data and stores it in the blockchain ledger at the time of publication. The badge provides readers with information about the CIS score and the extent of human versus AI involvement. The computing device 200 enables the badge to be interactive, allowing readers to access detailed information regarding the calculation of the CIS. This process ensures transparency, establishes content credibility, and allows audiences to make informed decisions regarding the authenticity and origin of the content.

After embedding a digital signature and verifying the originality of the content data, the computing device 200 time-stamps the content and records it on the blockchain, creating an immutable record. The blockchain record includes the original author's digital signature, the digital file's metadata, the Content Integrity Score (CIS), and a log of any subsequent modifications made to the content data. This configuration ensures that authorship is permanently linked to the content, and any alterations can be accurately tracked. The immutable blockchain record provides a secure foundation for content verification, enabling immediate detection of any tampering or unauthorized changes.

Once the content data has been verified and recorded on the blockchain, the computing device 200 publishes the content with a visible verification badge. The verification badge serves as a recognizable indicator of authenticity, providing readers with confidence in the legitimacy of the content. The badge is linked to the blockchain record, allowing readers to access detailed information regarding content creation, authorship, and modification history. Through this link, readers can verify that the original author's digital signature, the metadata, the CIS, and any subsequent changes are all recorded on the blockchain, thereby offering a comprehensive view of the content's lifecycle.

The computing device 200 further enables public verification through blockchain transparency. Readers can access the blockchain record to validate key information about the content, including the original author's digital signature, confirming that the content was created by a verified individual. The readers can also view the digital file's metadata, such as the date of creation, author details, and version history. Any subsequent modifications are logged in the blockchain, producing a detailed audit trail. This transparency ensures that the integrity of the content data is preserved, and that any attempt to alter it is recorded for verification.

The combination of AI analysis, blockchain recording, originality scoring, and verification badges ensures content integrity and trustworthiness. By storing the original author's digital signature, metadata, CIS, and any changes on the blockchain, the computing device 200 establishes a permanent and verifiable link between the content data and its creator. This process combats misinformation by guaranteeing that only verified and traceable content is published. Readers can be confident that the content is authentic, has not been tampered with, and is supported by an auditable, blockchain-based verification process. The transparency offered by this approach fosters trust, providing assurance that the information accessed is credible and reliable. In one embodiment, the author device includes a fingerprint recognition device configured to detect a fingerprint of the author. The author device includes a processing device coupled with the fingerprint recognition device. The processing device generates fingerprint data based on the detection. The identity data includes the fingerprint data.

In one embodiment, the author device includes a camera configured to detect a government-issued identity of the author. The author device includes a processing device coupled with the camera. The processing device generates government-issued identification data. The identity data includes the government-issued identification data. The government-issued identity data includes one or more of a passport, identification card, driver's license, student ID, birth certificate, voter registration card, and work ID.

In one embodiment, the identity data includes a name data representing the name of the author. In another embodiment, the identity data includes a password data representing a string of characters provided by the author. The password data is confidential. In one embodiment, the entity device includes a reader device. The reader device is associated with a reader accessing the content data.

In one embodiment, the digital signature data includes a date data representing the date of receiving the identity data. In another embodiment, the digital signature data includes a timestamp data representing the time of receiving the identity data. In yet another embodiment, the digital signature data includes a name data representing the name of the author. In another embodiment, the author device includes a camera configured to detect a signature of the author. The author device includes a processing device coupled with the camera. The processing device generates signature data based on the detection. The identity data includes the signature data.

In yet another embodiment, the author device includes an input device configured to receive a signature of the author based on finger swiping performed by the author. The author device includes a processing device coupled with the input device. The processing device generates signature data based on the receiving of the signature. The identity data includes the signature data.

In yet another embodiment, the author device includes an audio recognition device configured to detect audio. The author device includes a processing device coupled with the audio recognition device. The processing device generates audio data based on the detection. The content data includes the audio data.

In yet another embodiment, the author device includes an input device configured to receive text from the author. The author device includes a processing device coupled with the input device. The processing device generates text data based on the receiving of the text. The content data includes the text data. The text data includes one or more article, a poem, a story, news, a case study, technical writing, a website content, and a product description.

In yet another embodiment, the author device includes an input device configured to allow the author to upload the content data. The content data includes one or more of text data representing a text, image data representing an image, audio data representing audio, and video data representing a video.

In yet another embodiment, the author device includes an input device configured to receive a video from the author. The author device includes a processing device coupled with the input device. The processing device generates video data based on the receiving of the video. The content data includes the video data.

The digital signature data includes a combination of one or more of a name data representing the name of the author, a timestamp data representing the time of receiving of the identity data, and a date data representing the date of receiving of the identity data.

In yet another embodiment, the author device includes a voice recognition device configured to detect a voice of the author. The author device includes a processing device coupled with the voice recognition device. The processing device generates voice data based on the detection. The identity data includes the voice data. The verification query data includes one or more OTP requests, a password request, and a captcha request. The verification response data includes an OTP, a password, and a captcha.

The computing device 200 refines the content data based on a rule data. The content data includes an indecent audio, indecent video, indecent text, and indecent image. The rule data includes an indication of indecency. The author device includes one or more of a laptop computer, a tablet computer, a smartphone, a wearable computer, and a desktop computer. The entity device includes a user device comprising one or more of a social media platform, a website, an application, and a search engine, configured to access the content data. The user device is operated by one or more readers. The hierarchical content data structure is accessed by the author device and the entity device associated with a reader. The hierarchical content data structure includes a corresponding timestamp data representing one or more of a time of content creation and content upload. The hierarchical data structure includes corresponding timestamp data representing one or more of a time of content creation and content upload.

In yet another embodiment, the author device includes an input device configured to receive an image from the author. The author device includes a processing device coupled with the input device. The processing device generates image data based on the receiving of the image. The content data includes the image data.

The digital signature data includes one or more of a first digital signature data associated with a first portion of the content data and a second digital signature data associated with a second portion of the content data.

The method for verifying authenticity is applicable to a broad range of digital media types, including but not limited to text-based media, audio-based media, video-based media, image-based media, digital collectibles, and interactive or software-related content. The text-based media includes, without limitation, electronic books, articles, blogs, social media posts, forum comments, AI-generated stories, and simulation data. The audio-based media includes, without limitation, digital music, podcasts, audiobooks, voice recordings, and AI-generated audio content. The video-based media includes, without limitation, full-length films, short films, documentaries, user-generated videos on streaming platforms, live-streaming content, AI-generated deepfakes, GAN-generated videos, and AI-generated scripts for video interpretation. The image-based media includes, without limitation, photographs, digital artwork, and AI-generated visuals. The digital collectibles include, without limitation, tokenized digital assets such as NFTs. The interactive and software-related content includes, without limitation, video game binaries, game assets, and augmented or virtual reality environments. The method is designed to verify authenticity, trace origin, and prevent misattribution, tampering, or falsification across these diverse digital content types, and the disclosed categories are exemplary and not limiting.

Advantageously, the system cryptographically verifies the author's identity and securely ties it to the content data, providing proof of origin. This functionality ensures that credit is given to the original creator, particularly for copyrighted materials. For example, when a digital artwork is uploaded to the platform, the system associates the author's identity permanently with the artwork, enabling any viewer or purchaser to verify the true creator. This process protects intellectual property and ensures recognition for the author's work.

The system tracks all modifications to the content data through an immutable blockchain ledger, creating a tamper-proof history. Any changes made to the content after upload are recorded, and an audit trail is maintained for each modification. For instance, if a news video or audio clip is edited after publication, the system records the modifications on the blockchain, providing transparency regarding the evolution of the content and ensuring that audiences can verify when and how changes occurred.

The system generates a unique timestamp for each entry in the blockchain, ensuring accurate record-keeping. Timestamping provides a verifiable indication of when the content was created or modified. For example, a digital book uploaded by an author includes a timestamp representing the exact date and time of publication. This capability establishes priority and ownership, which is critical in resolving copyright disputes or verifying the first publication of a work.

The system enables traceable ownership by recording the entire lifecycle of the content data on the blockchain, from creation to modification. Each stage of the content, including updates or revisions, is verifiably linked to the original author. For instance, a digital artwork or a news video can be traced from its creation, through any subsequent modifications, to its final published form. Similarly, a digital book has a transparent history showing each update made by the author. This traceability ensures that content remains credible, ownership is clearly defined, and intellectual property rights are protected.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the essential scope thereof. Therefore, it is intended that the disclosure not be limited to the particular embodiments disclosed for carrying out this disclosure, but that the disclosure will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

What is claimed is:

1. A system for provisioning content authenticity, comprising:
at least one computing device comprising at least one processor and a memory storing a plurality of program modules;
at least one database in communication with the computing device via a network, wherein the database comprises data related to author and data for providing content authenticity, and
at least one author device associated with an author, in communication with the computing device via the network,
wherein the computing device is configured to:
receive an identity data from the author device and verify the identity data of the author;
generate a digital signature data based on the identity data, wherein the generation is based on a signature artificial intelligence model;
receive a content data from the author device;
embed the digital signature data into the content data;
generate a content integrity score (CIS) data for the content data and generate a verification badge data based on the content integrity score data, wherein the CIS data comprising a content integrity score is calculated based on at least one of an extent of manual author input, an extent of use of artificial intelligence tools, and an amount of artificial intelligence generated content within the content data, and
transmit the verification badge data to an entity device, wherein the verification badge data comprises the content data comprising the digital signature data.

2. The system of claim 1, wherein the computing device is configured to generate the digital signature data by:
transmitting the identity data to a certification authority entity, and
receiving the digital certificate data from the certification authority entity, wherein the digital certificate data represents a certificate issued by the certification authority entity to validate the identity data, wherein the digital signature data comprises the digital certificate data.

3. The system of claim 1, wherein the computing device is configured to verify the identity data of the author by performing multi-factor authentication (MFA).

4. The system of claim 1, wherein the identity data comprises biometric data and identification documents issued by a certified authority, wherein the computing device is configured to analyse the biometric data and the identification documents to verify the identity data.

5. The system of claim 1, wherein the computing device is configured to verify the identity data of the author by:
generating a verification query data based on the identity data;
transmitting the verification query data to the author device, and
receiving a verification response data based on the verification query data from the author device.

6. The system of claim 1, wherein the computing device is further configured to:
transform the content data comprising the digital signature data into a plurality of content data comprising the corresponding digital signature data;
perform a first analysis of the plurality of the content data;
generate a hierarchical content data structure comprising the plurality of content data comprising the corresponding digital signature data, and
store the hierarchical content data structure, wherein the hierarchical content data structure is associated with a corresponding index data, wherein the hierarchical content data structure is accessed based on the corresponding index data.

7. The system of claim 1, wherein the computing device is further configured to:
transform the identity data into a plurality of identification data;
performing a second analysis of the plurality of the identification data, and
generating a hierarchical data structure comprising the plurality of identification data, wherein the generating is based on the second analysis, wherein each identification data is associated with an index data configured to allow accessing the corresponding identity data within the hierarchical data structure based on the index data.

8. The system of claim 1, wherein the computing device is further configured to:
transform the content data comprising the digital signature data into a plurality of content data comprising the corresponding digital signature data;
perform a third analysis of the plurality of the content data;
generate a plurality of blocks comprising the plurality of content data comprising the corresponding digital signature data, and
transmit the plurality of blocks across the network associated with a plurality of devices, wherein the plurality of device comprises at least one of the author devices and the entity device.

9. The system of claim 8, wherein the computing device is further configured to:
receive alternate content data from the author device, and
update the plurality of blocks based on the alternate content data.

10. The system of claim 1, wherein the verification badge data comprises at least one of the content data and a public key data.

11. The system of claim 1, wherein the computing device is further configured to transmit the verification badge data and content integrity score to a blockchain node for storage in a distributed ledger.

12. The system of claim 1, wherein the computing device is configured to receive the content data by:
provide an author interface at the author device configured to allow creation, editing, and uploading of the content data;
perform ongoing biometric verification of the author during content creation;
generate a hash value of the content data;
automatically generate metadata associated with the content data, and
transmit the hash value and the metadata to the blockchain node for storage in the distributed ledger, wherein the distributed ledger is maintained by a plurality of blockchain nodes across the network.

13. The system of claim 1, wherein the verification badge data comprises verification badge, wherein the verification badge indicates one of human-generated content, human content assisted by artificial intelligence, content generated by artificial intelligence, or content generated through a combination of human input and artificial intelligence, wherein the verification badge is visually embedded within the content data.

14. The system of claim 13, wherein the verification badge is selectable to display details about the content integrity score and the level of human versus artificial intelligence involvement in creating the content data.

15. The system of claim 1, wherein content data, after embedding the digital signature data and verifying originality, is time-stamped and recorded on the blockchain ledger comprising a log of subsequent changes to the content data.

16. The system of claim 13, wherein the blockchain ledger is publicly accessible for verification of authorship, metadata, digital signature data, verification badge, content integrity score, version history, and subsequent modifications of the content data.

17. A method for provisioning content authenticity, comprising:
providing at least one computing device comprising at least one processor and a memory storing a plurality of program modules, at least one database in communication with the computing device via a network, and at least one author device associated with an author, in communication with the computing device via the network, wherein the database comprises data related to author and data for providing content authenticity;
receiving, at the computing device, an identity data from the author device and verify the identity data of the author;
generating, at the computing device, a digital signature data based on the identity data, wherein the generation is based on a signature artificial intelligence model;
receiving, at the computing device, a content data from the author device;
embedding, at the computing device, the digital signature data into the content data;
generating, at the computing device, a content integrity score (CIS) data for the content data and generate a verification badge data based on the content integrity score data, wherein the CIS data comprising a content integrity score is calculated based on at least one of an extent of manual author input, an extent of use of artificial intelligence tools, and an amount of artificial intelligence generated content within the content data, and
transmitting, at the computing device, the verification badge data to an entity device, wherein the verification badge data comprises the content data comprising the digital signature data.

18. The method of claim 17, wherein the computing device is configured to receive the content data by:
providing an author interface at the author device configured to allow creation, editing, and uploading of the content data;
performing ongoing biometric verification of the author during content creation;
generating a hash value of the content data;
automatically generating metadata associated with the content data, and
transmitting the hash value and the metadata to the blockchain node for storage in the distributed ledger, wherein the distributed ledger is maintained by a plurality of blockchain nodes across the network.

19. The method of claim 18, wherein content data, after embedding the digital signature data and verifying originality, is time-stamped and recorded on the blockchain ledger comprising a log of subsequent changes to the content data.

20. The method of claim 18, wherein the blockchain ledger is publicly accessible for verification of authorship, metadata, digital signature data, verification badge, content integrity score, version history, and subsequent modifications of the content data.
